(19) United States
(12) Patent Application Publication
(10) Pub. No.: US 2016/0094810 A1
(43) Pub. Date: Mar. 31, 2016

(54) SYSTEM AND METHOD FOR PROVIDING NEIGHBORHOOD SERVICES THROUGH NETWORKED CAMERAS

(71) Applicant: VERIZON PATENT AND LICENSING INC., Arlington, VA (US)

(72) Inventors: Momin MIRZA, Santa Clara, CA (US); Yunji FENGSHI, Guilderland, NY (US)

(21) Appl. No.: 14/502,617

(22) Filed: Sep. 30, 2014

(51) Int. Cl. H04N 7/18; H04N 5/247; H04L 29/08

(52) U.S. Cl. CPC H04N 7/181; H04L 67/125; H04N 5/247

(57) ABSTRACT

An approach for implementing a network of cameras for providing one or more services in a neighborhood is provided. The approach includes creating a network of cameras, wherein the cameras are associated with one or more users participating in the network. The approach also includes stitching one or more images, one or more videos, or a combination thereof captured by the cameras to generate a composite image, a composite video, or a combination thereof. The approach also includes providing access to the composite image, the composite video, the network, or a combination thereof to the one or more users.

### BACKGROUND INFORMATION

Video cameras have traditionally been used for security surveillance of an area or location. Due to advancement of computing technologies along with improved storage devices and communication networks, cameras are being put to many uses supporting various applications. One such application is the surveillance over closed network circuits. For example, Closed-circuit Television (CCTV) cameras are in widespread usage for surveillance of a location and associated events. The CCTV cameras are deployed in homes, offices, shopping malls, busy markets, and public places for performing surveillance of thereof. The cameras are then only used for a specific home, work place, or location and the video recorded is stored and can only be viewed on site.

Additionally, a traditional neighborhood watch programs are implemented by having residents on a block or within a certain locality or neighborhood watch for strange vehicles, persons and other uncommon events in order to achieve a secure and safe environment of the residents thereof. Even then, residents generally have camera networks of their own for their own property for instances that are not captured by the neighborhood watch.

However, there are several shortcomings in the existing surveillance solutions. For example, the existing solutions employ individual cameras to monitor a particular location, which is limited by field of view of the camera. Individuals may also only be able to afford lower quality cameras. A camera having large field of view and higher quality image can monitor a larger area and retain greater details about the goings-on of the location, however, increased quality of cameras is expensive and cumbersome. As well, increasing the quantity of cameras for greater coverage on a property can be expensive.

Some existing solutions, instead of deploying cameras with large field of view, deploy multiple cameras at various locations within or around an area to be monitored. For example, in a large building, CCTV cameras are deployed at reception area, in the lobbies, in the restaurant, and at the gates of the building. Each of the CCTV cameras captures and transmits images or videos to a control room where the images or videos are displayed at multiple screens. Each CCTV camera has a corresponding display screen in the control room displaying images or videos in the field of view of that CCTV camera. However, even the deployment of multiple cameras in the existing surveillance solutions fails to provide satisfactory surveillance due to discrete nature of monitoring data including the captured images or videos.

Therefore, there is a need for providing effective surveillance and monitoring of a neighborhood or location.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing surveillance and other services via a network of cameras, according to one embodiment;

FIG. 2 is a diagram of the components of a networked camera platform for surveillance and other services, according to one embodiment;

FIG. 3 through FIG. 5 are flowcharts illustrating methods for providing surveillance and other services via a network of cameras, according to one embodiment;

FIG. 6A is a diagram illustrating an exemplary arrangement of a network of cameras, according to one embodiment;

FIG. 6B is a diagram illustrating exemplary stitched view and corresponding component views of a neighborhood, according to one embodiment;

FIG. 6C is a diagram illustrating an exemplary view from a camera, according to one embodiment;

FIG. 6D is a diagram illustrating an exemplary user interface of a device for receiving alerts corresponding to events captured by a network of cameras, according to one embodiment;

FIG. 6E is a diagram illustrating an exemplary use case wherein a lost pet is tracked using a network of cameras, according to one embodiment;

FIG. 6F is a diagram illustrating an exemplary user interface of a device for receiving an alert related to the lost pet of FIG. 6E, according to one embodiment;

FIG. 7 is a diagram illustrating an exemplary user interface of a device for receiving multiple alerts from the network of cameras, according to one embodiment;

FIG. 8 is a diagram of a computer system that can be used to implement various exemplary embodiments; and

FIG. 9 is a diagram of a chip set that can be used to implement an embodiment of the invention.

### DESCRIPTION OF THE PREFERRED EMBODIMENT

An apparatus, method and software for facilitating a network of cameras providing surveillance and one or more other services in a neighborhood are disclosed. In the following description, for the purposes of explanation, numerous specific details are set forth in order to provide a thorough understanding of the present invention. It would be apparent, however, to one skilled in the art that the present invention may be practiced without these specific details or with an equivalent arrangement. In other instances, well-known structures and devices are shown in block diagram form in order to avoid unnecessarily obscuring the present invention.

In one embodiment, many homes within a neighborhood have their own network of cameras as surveillance for their own homes. The addition of more cameras would make the surveillance of the occupant's home more complete and protect from more additional threats or at least, in order to better determine a perpetrator of crimes against the home and its occupants. In order to best do this, the present invention makes occupants, subscribers, this grants surveillance through the use of the neighbor's home surveillance cameras in addition to their own cameras. Each homes' cameras being on different networks makes this task more difficult, as well as, determining which cameras to use based on their field of view, e.g., cameras viewing the inside of a home would not be a part of this networking of neighborhood cameras. But the present invention provides a solution to this problem to create greater safety in numbers as well as address additional neighborhood issues, e.g., finding lost objects or notifying neighbors of potential dangers.

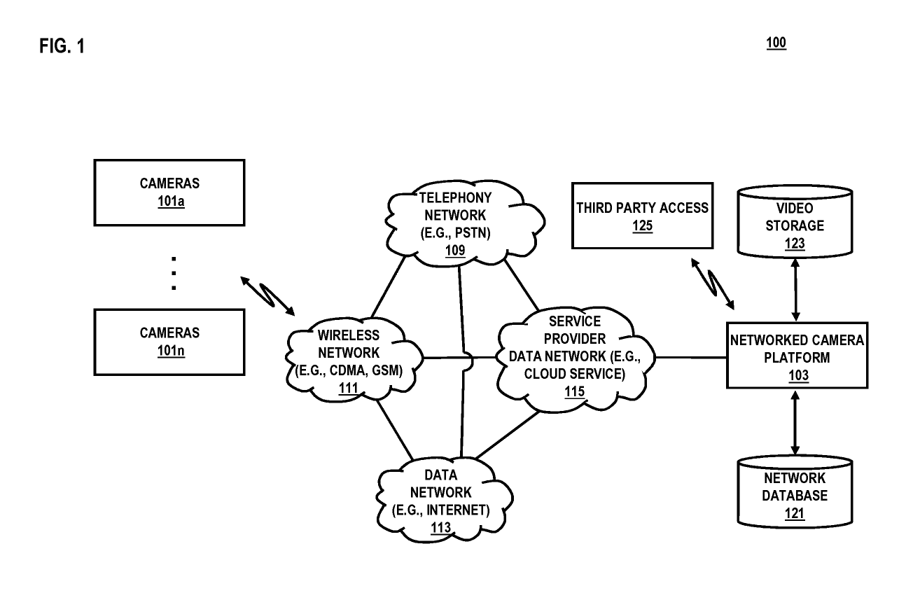

FIG. 1 is a diagram illustrating a system 100 for implementing a network of cameras in a neighborhood. The system 100 includes cameras 101a-101n (cameras 101 for plural and camera 101 for singular) communicatively coupled to a networked camera platform 103 via one or more networks 109-115. The networked camera platform 103 may have coupled to it a video storage 123, a network database 121 and a third party access (interface) 125.

In one embodiment, the one or more networks 109-115 may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109, 111, 113, and 115 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

In one embodiment, the network database 121 may include information related to cameras 101 and associated functionalities. For example, the network database 101 may include information related to a location of a camera, a type of the camera, identification information of the camera, a list of images or videos captured using that camera, a network type of a network communicatively coupling the cameras 101 to the networked camera platform 103. The network database 121 may further include information regarding bandwidth capabilities of the cameras 101 and of communication links between the cameras 101 and the networked camera platform 103.

The network database 121 may be implemented by using any known or developing proprietary or open source technologies. The network database 121 may allow the definition, creation, querying, update, and administration of information or data stored therein. The network database 121 may also be located locally or remotely with respect to the networked camera platform 103. In one embodiment, the network database 121 may include a distributed database.

In one embodiment, the third party access 125 may provide access to the video storage 123 or a part of the video storage 123 to third parties, for example, law enforcement agencies. The third party access 125 may include user interfaces, devices, systems and methods provided by a service provider to allow parties not actually participating in the network of cameras to access data, information, services offered by the system 100.

In one embodiment, the video storage 123 is any type of storage capable of holding and enabling retrieval, storage, and updating of any data or information. In one embodiment, the video storage 123 may store one or more videos and one or more images captured by the cameras 101. The video storage 123 may be implemented as a file system or a database system or a combination thereof. The video storage 123 may include a variety of storage units implemented using a variety of technologies. The video storage 123 may be implemented as a distributed database. The video storage 123 may be implemented using one or more of Blu-ray Discs, compact discs, digital versatile disc, hard disc, static hard disk, laserdisc, and holographic memory. In one embodiment, the video storage 123 may include cloud storage. In another embodiment, the video storage 123 may include discrete storage units for each of the cameras 101. In one contemplated embodiment, the video storage 123 may be implemented in part on the one or more of the cameras 101, in part on the networked camera platform 103, and in part on the cloud storage (not shown).

The system 100 may provide one or more services in the neighborhood. In one embodiment, the one or more services may include, but not limited to general surveillance of the neighborhood, law enforcement services, lost and found services, object identification and tracking services.

The cameras 101 coordinate with one another to provide the one or more services in the neighborhood. For example, the cameras 101 coordinate to provide composite images or videos of the neighborhood for providing effective surveillance services.

A user may participate in the network of cameras by coupling his or her camera to the network of the cameras. In one embodiment, a user may contribute more than one camera to the network of the cameras. On the other hand, a single camera may be contributed by more than one user. In one embodiment, the cameras 101 may be installed in the neighborhood by a service provider. In this embodiment, the residents of the neighborhood or other users may subscribe to the one or more services provided by the system 100.

A user may be charged for the services provided by the system 100. The charge rate may vary with a plan subscribed to by the user. For example, a user subscribing to access high resolution videos or images may be charged at a higher rate than a user who subscribe for accessing medium or low resolution videos or images. A user may subscribe only for data relevant to him or her. For example, a civilian user living in a street 1 may only subscribe to the data associated with the street 1 and not subscribe for data associated with a street 2. On the other hand, a user responsible for law enforcement or regular neighborhood watch, such as, a security guard may subscribe to the data associated with both the street 1 and the street 2. In another case, a user without cameras may subscribe at yet another higher rate. The information/data collected at the video storage 123 may be put to many uses. In one embodiment, the data may be used for identification and tracking of objects in the neighborhood.

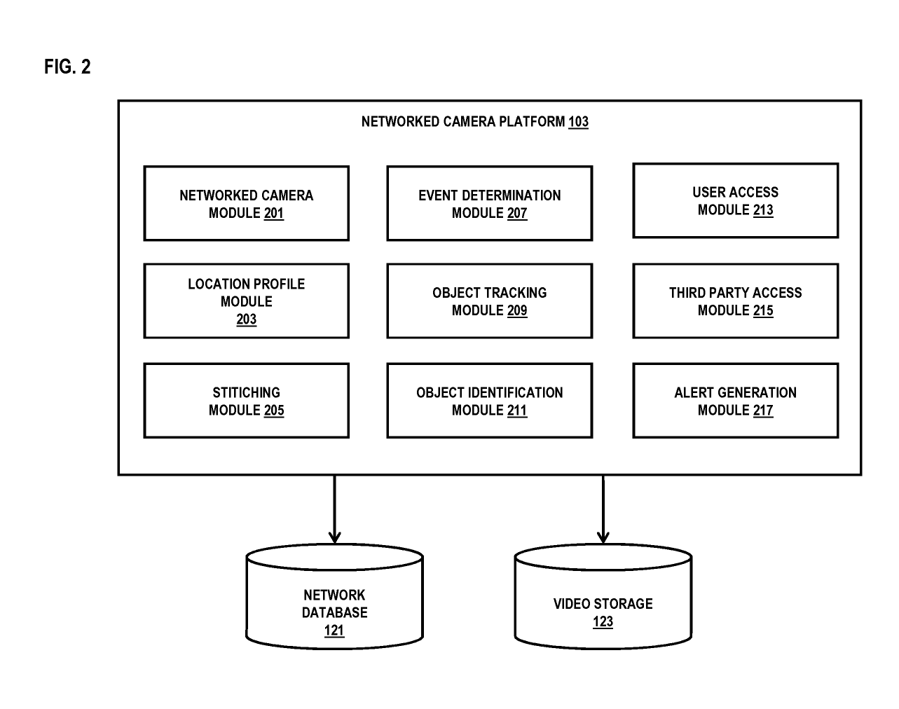

In one embodiment, the data collected by the system 100 may provide for enhanced services in the neighborhood. For example, the videos or images of the neighborhood may provide demographic, geographical, and economical indicators to a subscriber. A service provider may subscribe to this information and provide his or her services based on the above information. The information may also be used to provide targeted advertisements to the residents of the neighborhood. The information captured with the cameras may be used for special events such as marriages, parties, and the information can be provided to the organizer of the event for a fee. Detailed working of the system 100 and its components is described below with reference to FIG. 2.

FIG. 2 is a block diagram illustrating various components or modules of the networked camera platform 103 communicatively coupled to the network database 121 and the video storage 123 for providing one or more services in the neighborhood, according to one embodiment. In one embodiment, the networked camera platform 103 may include, a networked camera module 201, a location profile module 203, a stitching module 205, an event determination module 207, an object tracking module 209, an object identification module 211, a user access module 213, a third party access module 215, and an alert generation module 217. The modules 201-217 may communicate with one another and other components of the system 100 to facilitate coordination of cameras 101 to provide one or more services in the neighborhood.

The networked camera module 201 may be configured for receiving and processing the information associated with the cameras 101 from the network database 121 and may access information stored in the network database 121. The network camera module 201 may create a network of the cameras 101. The networked camera module 201 may create the network of camera 101 in a neighborhood by communicatively coupling the cameras 101 with the networked camera platform 103.

In one embodiment, the networked camera module 201 may enable the cameras 101 for communicating with one another for sharing information such as images and videos. In one embodiment, the networked camera module 201 may create an association between the cameras 101 and one or more users participating in the network of cameras 101. A camera of the network of cameras 101 may be associated with one or more users and one user may be associated with one or more cameras if the network of cameras 101. The cameras 101 may capture one or more images, one or more videos or a combination thereof.

In one embodiment, the networked camera module 201 may receive images or videos from the cameras 101 and preprocess the received images or videos. In one embodiment, the networked camera module 201 may timestamp the received images or videos.

In one embodiment, the networked camera module 201 may monitor and control various parameters associated with the cameras 101. The various parameters associated with the cameras 101 may include, but not limited to, information related to a location of a camera, a type of the camera, identification information of the camera, a list of images or videos captured using that camera, a network type of a network communicatively coupling the camera to the networked camera platform 103. The networked camera module 201 may further monitor and/or control bandwidth capabilities of cameras 101 and of communication links between the cameras 101 and the networked camera platform 103. The identification information of a camera 101 may include, but not limited to a Media Access Control (MAC) address of the camera, a unique address of the camera on the network of the cameras, a relative device number of the cameras 101 with respect to other devices in the network of cameras 101. In one embodiment, the unique address of the camera may include a uniform resource identifier (URI) or a unique resource locator (URL).

The networked camera module 201 may be configured to act as an intermediation platform for the networked camera platform 103 and the video storage 123 and the network database 121. The intermediation platform may support and facilitate intercommunication by establishing communication links between devices of different types and incompatible communication protocols. The networked camera module 201 may receive and transmit data and information from and to other modules of the networked camera platform 103.

The networked camera module 201 may monitor working of the cameras 101 installed at appropriate positions in the neighborhood. In one embodiment, the networked camera module 201 may monitor an orientation of a camera and may include or exclude the camera from the network of cameras based on the orientation of the camera. For example, a camera facing the street may be included in the network of the cameras by the networked camera module 201. On the other hand, a camera facing inside of a house or installed inside of the house may not be included in the network of the cameras. In one embodiment, the networked camera module 201 may dynamically change the configuration of the network of cameras based on orientation of the cameras 101. For example, a camera facing the street is included in the network of the cameras, however, if the orientation of the camera is changed so that it faces away from the street or towards inside of a house, that particular camera can be removed from the network of the cameras by the networked camera module 201.

In one embodiment, a camera may be activated or deactivated by the networked camera module 201 based on presence information associated with one or more users. For example, a cameras may be activates when there are children playing in the street or park and may be deactivated when there is no child in the street or the park. In one embodiment, the networked camera module 201 may enable one or more users to remotely control the cameras 101.

The location profile module 203 of the networked camera platform 103 may be configured to create location profiles for the cameras 101. The location profile of a camera may include positioning information of the camera in a neighborhood. The positioning information may be relative positioning information, for example, with respect to a street and with respect to other cameras of the network of cameras. In one embodiment, an absolute positioning of the camera may be determined based on global positioning system (GPS) unit included in the camera. In one embodiment, the location profile module 203 may update a location of a camera if the camera is shifted from a first position to a second position in the neighborhood. The location profile module 203 may provide data related to locations of the cameras 101 to the networked camera module 201 for further processing.

The stitching module 205 may be configured to stitch images or videos received from the cameras 101. In one embodiment, the stitching module 205 may stitch the received images or videos to generate a composite image or a composite video at the networked camera platform 103. The stitching of images to generate a composite image may be achieved using any known proprietary or open source technique and/or algorithm. Similarly, the stitching of videos to generate a composite video may be achieved using any known proprietary or open source technique and/or algorithm.

The stitching module 205 may determine whether images captured by one camera are sequential to the images captured by the next camera. The stitching module 205 may determine a sequence of images or videos for generation of a composite image or composite video. In one embodiment, the sequence of images or videos may be based on the orientation information associated with the cameras 101. For example, an image or video captured by a camera facing main gate of a street may be placed before an image or video captured by a camera facing inside of the street in the sequence of the images or videos. In one embodiment, the sequence of images or videos may be based on the location information associated with the cameras 101. For example, an image or video captured by a camera installed on first house of the street may be placed before an image or video captured by a camera installed on a second house of the street in the sequence of the images or videos.

In one embodiment, the sequence of images or videos may be based on field of view information associated with the cameras 101. For example, an image or video captured by a camera having a larger field of view may be placed before an image or video captured by a camera having a smaller field of view in the sequence of the images or videos. Further, the field of view information may also include angular field of view and linear field of view information. In one embodiment, the sequence of images or videos may be determined based on a combination of the orientation information, the field of view information and the location information associated with the cameras 101.

In one embodiment, the stitching of images or videos may be based on the quality of images or video from each camera, with each camera providing a different level of definition and detail due to quality of the image or video recorded.

The object identification module 211 may be configured to identify objects in the neighborhood. For example, the object identification module 211 may identify lost pets or items as well as stolen vehicles in the neighborhood.

The object tracking module 209 may be configured to track one or more objects in the neighborhood. The object tracking module 209 may be configured to receive a request for tracking an object. The request for tracking the object may be received from an owner of the object such as pet or a vehicle. In one embodiment, the request may be received from a law enforcement agency to track stolen goods, such as a stolen vehicle. The object tracking module 209 may perform the tracking of the object based on a determination of presence information and movement information of the object. The presence information and the movement information may be determined based on a processing of one or more images, one or more videos, the composite image, and the composite video captured and/or generated by the network of cameras 101. In one embodiment, the location of an object may be determined based on the location of the camera which covers the field of view in which the object is seen at the moment. Further, the movement information of an object may be determined based on the images supplied by the network of cameras 101. In this way, a continuous tracking of an object in the neighborhood may be achieved.

The event determination module 207 may be configured to determine an event in the neighborhood. The event may be associated with identification and tracking of one or more objects. In one embodiment, the event may be identification of a lost pet or a stolen vehicle. In one embodiment, the event determination module 207 may also be configured to turn on and off surveillance cameras based on occupants being away from home or at home. In one embodiment, an event may include kids playing in the street or other large gatherings of persons, thus where the potential harm from danger increases, more definition and detail from the camera settings and more cameras may be initiated.

The user access module 213 may be configured to enable access of data stored in the video storage 123 and the network database 121 to users participating in the network of cameras.

The third party access module 215 may be configured to enable access of data stored in the video storage 123 and the network database 121 to users not participating in the network of cameras, i.e., third parties such as law enforcement or users of other networks of cameras.

The alert generation module 217 may be configured to generate an alert for an event in the neighborhood. For example, a stolen vehicle may be detected in the neighborhood, and an alert may be provided to a law enforcement agency, which may take an appropriate step based on the alert. In another example, a lost pet may be detected based on the images and videos associated with the neighborhood and an owner or security guard may be alerted about the location of the lost pet.

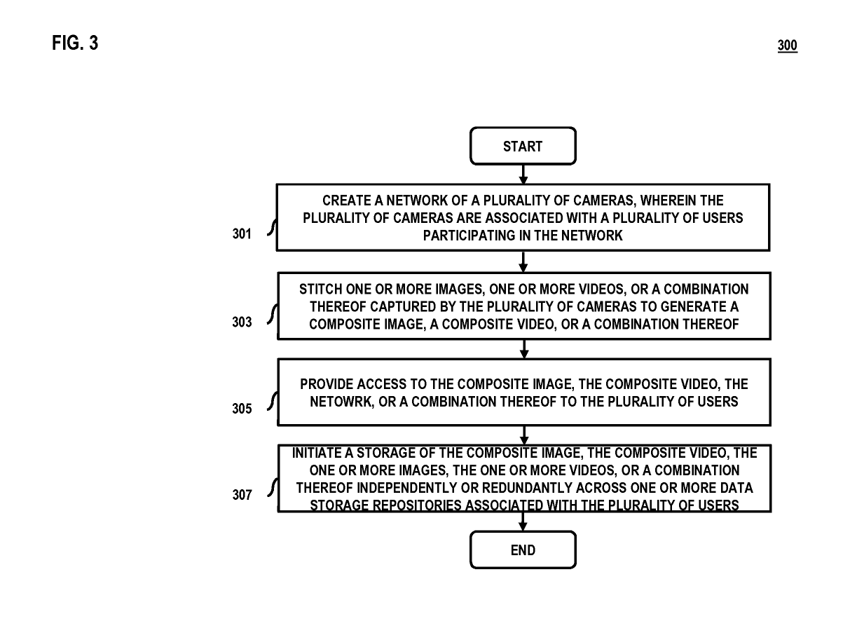

FIG. 3 is a flow chart 300 illustrating a method for a network of cameras 101, according to one embodiment. At step 301, a network of the cameras 101 is created. The network of cameras 101 may be created by communicatively coupling the cameras 101 with the networked camera platform 103. In one embodiment, the cameras 101 may communicate with one another for sharing information such as images and videos. In one embodiment, the cameras 101 are associated with one or more users participating in the network. One camera may be associated with one or more users and one user may be associated with one or more cameras. The cameras 101 may capture one or more images, one or more videos or a combination thereof. The captured one or more images and one or more videos may be transmitted to the networked camera platform 103 for further processing.

At step 303, the received one or more images and one more videos may be stitched to generate a composite image or a composite video at the networked camera platform 103. The stitching of images to generate a composite image may be achieved using any known proprietary or open source technique and/or algorithm. Similarly, the stitching of videos to generate a composite video may be achieved using any known proprietary or open source technique and/or algorithm.

At step 305, the composite image or the composite video may be made available to one or more users of the network. An access to the composite image or video may be provided to a user based on a subscription plan of the user. A variety of subscription plans may be offered to users from which a user can select one or more subscription plans as per his or her requirements. Some subscription plans may be priced higher than other subscription plans based on specific services provided under the subscription plans. For example, in one embodiment, a subscription plan providing access to high resolution images or videos may be priced higher than another subscription plan which provides access to low or medium resolution images or videos. A user may modify his or her subscription plan as per the requirements.

At step 307, the composite image or video and individual images or videos may be stored in the video storage 123. Data storage techniques may be utilized to provide required redundancy and efficiency in the system 100. Individual images may be stored separately from the composite images and selective access may be provided to a user. Similarly, individual videos may be stored separately from the composite videos and selective access may be provided to a user. In one embodiment, the individual and composite images may be stored separately from the individual and composite videos. In one embodiment, the video storage 123 may be external to the networked camera platform 103. In another embodiment, the video storage 123 may be internal and a part of the networked camera platform 103.

FIG. 4 is a flowchart 400 illustrating a method for determining images or videos to be included for generation of composite image or composite video, according to one embodiment.

At step 401, it is determined whether to include a particular camera in the network of cameras. The determination may be based on the orientation information. For example, a camera facing a street may be included and a camera facing inside of a house may be excluded from the network of cameras. In one embodiment, the determination on inclusion of a camera may be based on location information associated with the camera. For example, a camera having a location corresponding to a first street may be included and another camera having a location corresponding to a second street may be excluded from the network of cameras. In one embodiment, the determination on inclusion of a camera may be based on a combination of the orientation information and the location information.

At step 403, a sequence of images or videos is determined for generation of a composite image or composite video. In one embodiment, the sequence of images or videos may be based on the orientation information associated with the cameras 101. For example, an image or video captured by a camera facing main gate of a street may be placed before an image or video captured by a camera facing inside of the street in the sequence of the images or videos. In one embodiment, the sequence of images or videos may be based on the location information associated with the cameras 101. For example, an image or video captured by a camera installed on first house of the street may be placed before an image or video captured by a camera installed on a second house of the street in the sequence of the images or videos. In one embodiment, the sequence of images or videos may be based on field of view information associated with the cameras 101. For example, an image or video captured by a camera having a larger field of view may be placed before an image or video captured by a camera having a smaller field of view in the sequence of the images or videos. Further, the field of view information may also include angular field of view and linear field of view. In one embodiment, the sequence of images or videos may be based on a combination of the orientation information, the field of view information and the location information associated with the cameras 101.

In one embodiment, the generation of a composite image or video may include camera quality in determining which images or video are central to the composition. Higher quality image or video will take priority over lower quality images or video in order to get the best representation of the real time surveillance of the neighborhood network. Additionally, in one embodiment, the quality used by each camera may be changed, increased or decreased as needed. For example, if a camera detects uncommon movement the quality can be jumped to its highest level quality and if nothing is going on it can be dropped to its lowest level quality.

At step 405, the orientation information, the field of view information, and the location information may be determined. In one embodiment, the determination of the orientation information may be based on image processing information. For example, the orientation of a camera may be determined based on an analysis of images or videos captured by that camera. Further, the orientation of the camera may also be determined based on analysis of audio data associated with the videos captured by that camera. For example, sound and voice patterns or signatures of the audio data may be compared with predetermined voice signatures of various events and objects to determine whether a camera is facing inside of a house or facing the street.

In one embodiment, the determination of the location information may be based on location sensor information. The location sensor may be based on Global Positioning System (GPS) unit included in a camera. The GPS unit may further be augmented with other units and specialized techniques may be applied to determine a micro location of a camera. Further, in one embodiment the field of view information may be determined based on the image processing information and the location sensor information. Further, in one embodiment, the determination of the orientation information, the field of view information, and the location information may be based on a combination of the image processing information, the location sensor information, and the micro-location information.

FIG. 5 is a flowchart 500 illustrating a method of tacking objects and providing alerts, according to one embodiment.

At step 501, a request may be received at the networked camera platform 103 for tracking an object. The request for tracking the object may be received from an owner of the object such as pet or a vehicle. In one embodiment, the request may be received from a law enforcement agency to track a stolen good such a stolen vehicle.

At step 503, the tracking of the object may be initiated. The tracking of the object may be based on a determination of presence information and movement information of the object. The presence information and the movement information may be determined based on a processing of one or more images, one or more videos, the composite image, and the composite video captured and/or generated by the network of cameras 101.

At step 505, an alert may be generated based on the tracking of the object. The alert may indicate the presence information and the movement information of the object in the neighborhood. The alert may be in the form of a text message, a graphical icon, an audio, a video or a combination thereof.

At step 507, access to data associated with the tracking of the object may be provided to a user other than the users participating in the network of cameras. The data associated with the tracking of the object may include but not limited to the composite image, the composite video, the one or more images, the one or more videos or a combination thereof.

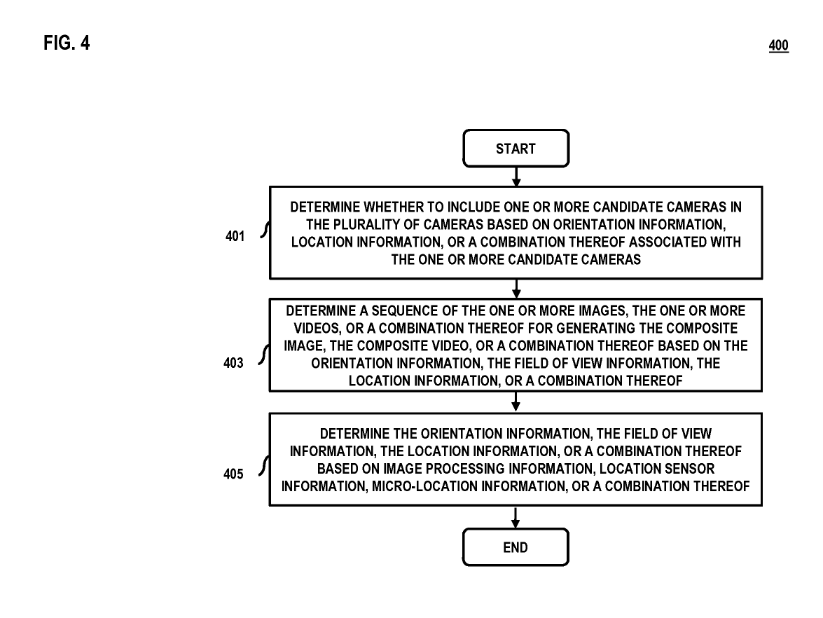

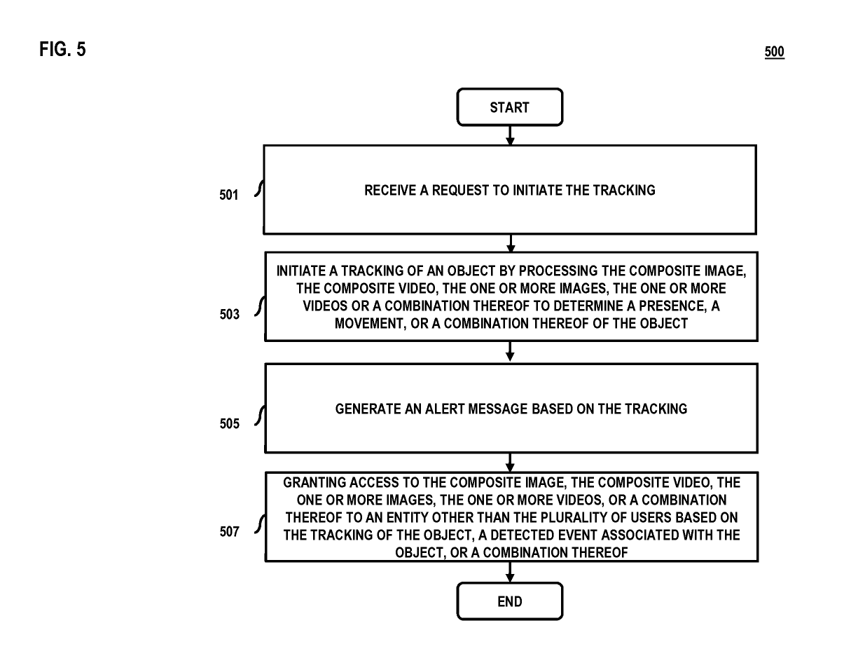

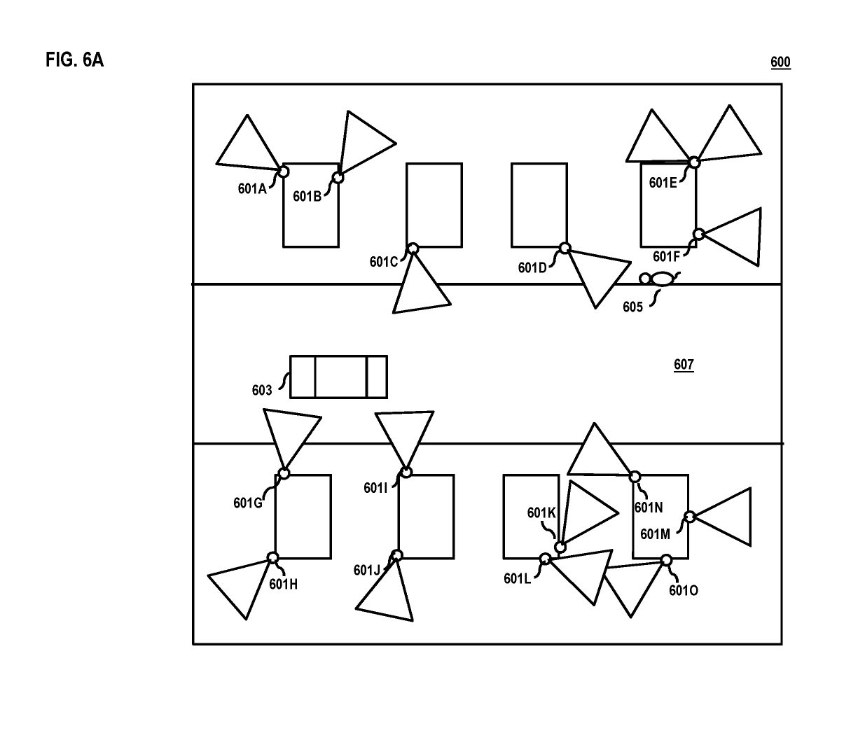

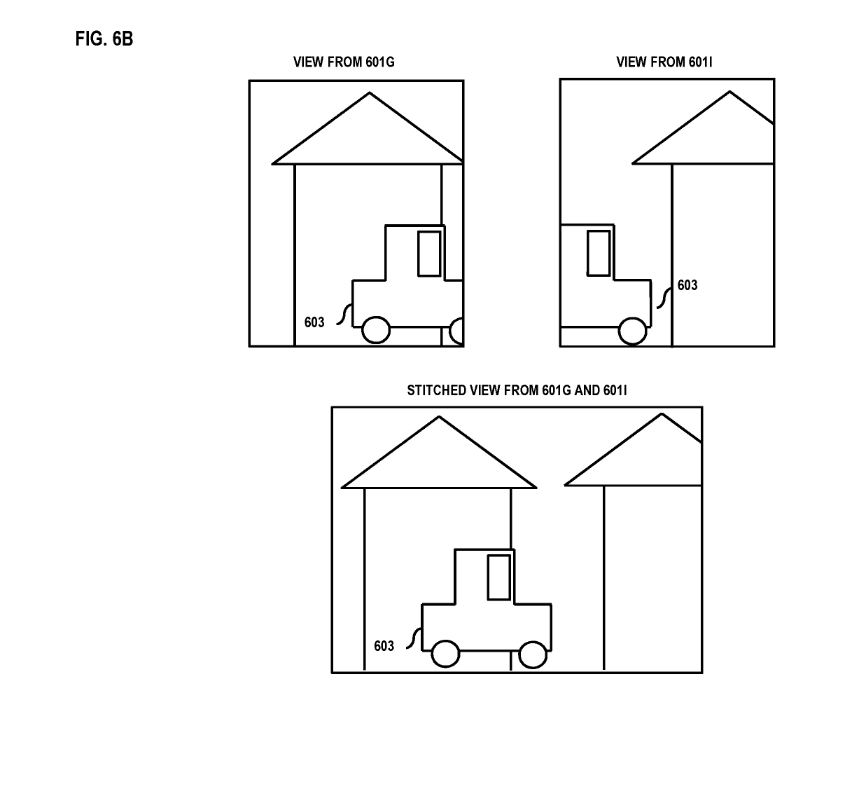

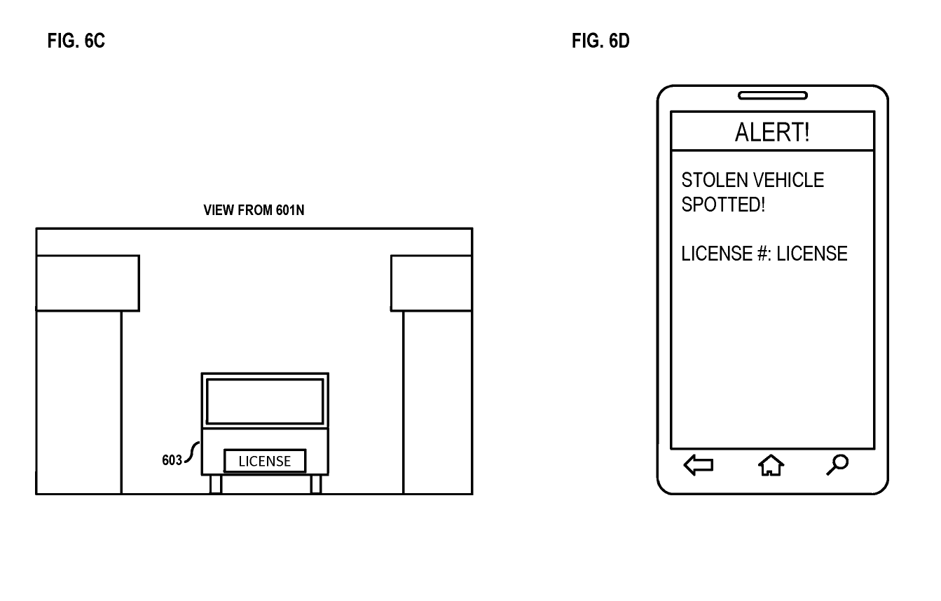

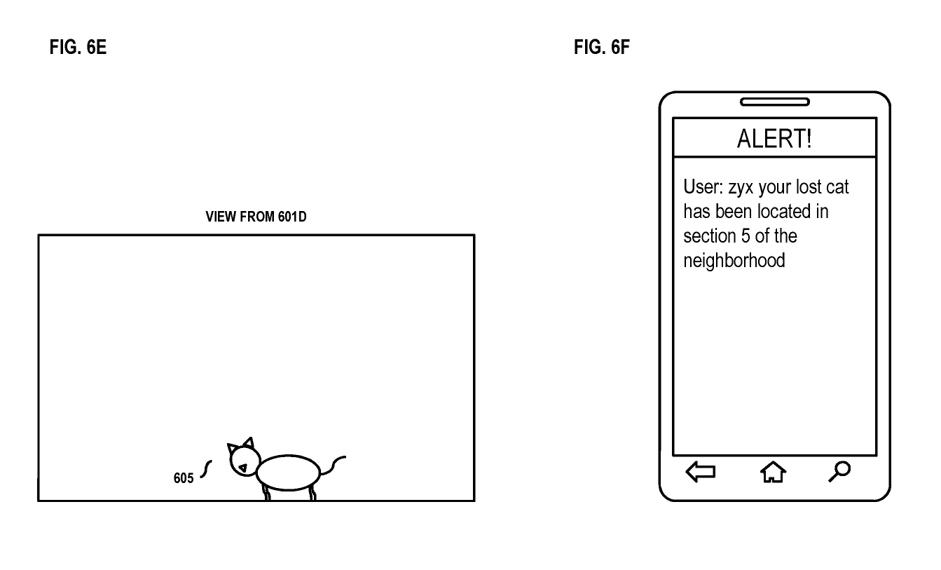

FIGS. 6A through 6F illustrate arrangement of cameras 101 for providing camera network services, according to one embodiment. In particular, FIG. 6A is a block diagram 600 which illustrates an arrangement of cameras 601A-6010 along a street 607, according to one embodiment. The cameras 601A-6010 may be installed in or at the houses located on both sides of the street 607. For example, cameras 601C, 601D, 601G, 601I, and 601N are oriented so that they face the street 607 and may capture images or videos associated with objects and events on the street 607. FIG. 6A further depicts a vehicle 603 and a pet 605 in the street 607. In one embodiment, the cameras 601A-6010 may capture images or videos related to the vehicle 603 and the pet 605.

FIG. 6B illustrates several views of the vehicle 603 in the street 607 according to one embodiment. An image of a front end of the vehicle 603 may be captured by the camera 601I and an image of a back end of the vehicle 603 may be captured by the camera 601G. Further, the images of the front end and the back end may be stitched together to generate a composite image of the vehicle 603, shown as stitched view from 601G and 601I. In one embodiment, part videos of the vehicle 603 may be stitched together to generate a composite video of the vehicle 603. The composite image or the composite video may be used by the system 100 to identify and track the vehicle 603 in the neighborhood.

FIG. 6C shows the vehicle 603 as viewed from the camera 601N. In particular, the view from the camera 601N shows a license plate of the vehicle 603. A vehicle number of the vehicle 603 may be captured in an image or a video from the camera 601N. Further, with reference to FIG. 6D, the vehicle number may be utilized to spot a stolen vehicle and a corresponding alert may generated and provided to an appropriate entity or person. For example, alert of spotting a stolen vehicle may be provided to a law enforcement agency and/or owner of the vehicle.

FIG. 6E shows a cat 605 in the street 607 as seen from the camera 601D. An image or video of the cat 605 captured by the camera 601D may be compared to a picture of the cat 605 provided by owner of the cat and it may be determined that it is the lost cat 605. An alert may be provided to the owner (zyx) of the cat 605 regarding the location of the cat 605 as shown in FIG. 6F.

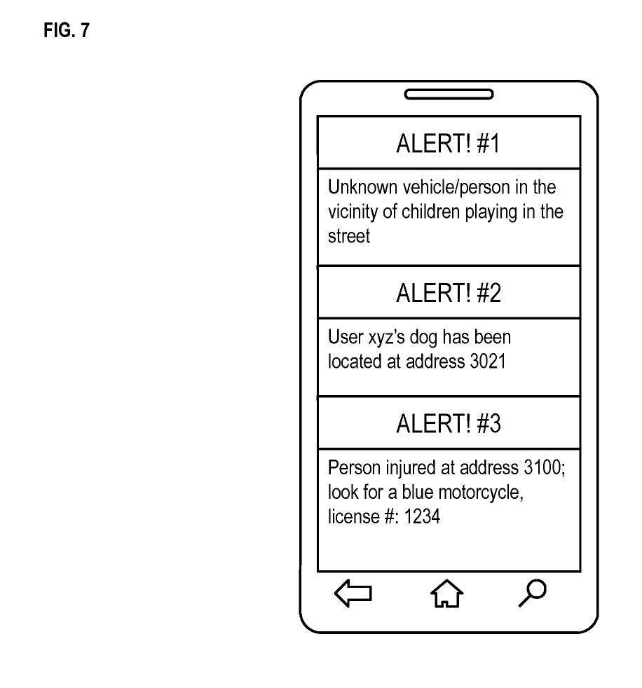

FIG. 7 illustrates a graphical user interface (GUI) for displaying various alerts to a user on his or her mobile device. For example, an alert, ALERT! #1 may be provided if an unknown person or vehicle is in vicinity of children playing in the street of the neighborhood. Another alert, ALERT! #2 may relate to finding of a lost dog of a user xyz at an address 3021. Another alert, ALERT! #3 may relate to a person who may have been injured at an address 3100. The alert may further include additional information such as license number of a motorcycle of the injured person. The GUI may be of a display screen of one or more of a mobile phone, a smart phone, a tablet, and a television (TV) associated with the users participating in the network of cameras 101 and third parties not participating in the network of cameras.

Thus, the system 100 provides effective general surveillance of the neighborhood, law enforcement services, lost and found services, object identification and tracking services with the network of the cameras.

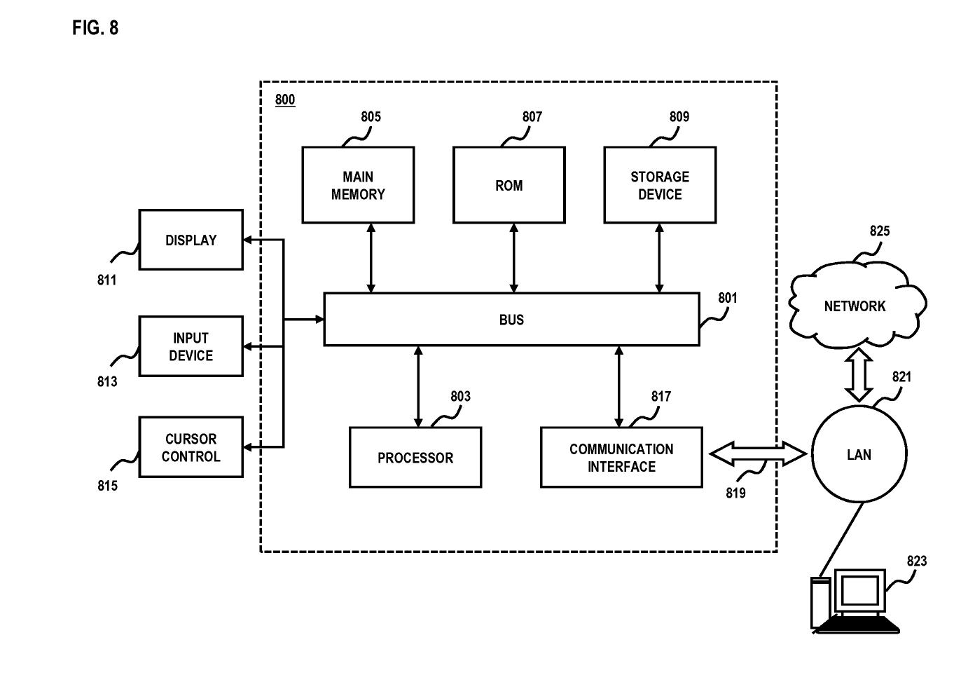

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 901 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

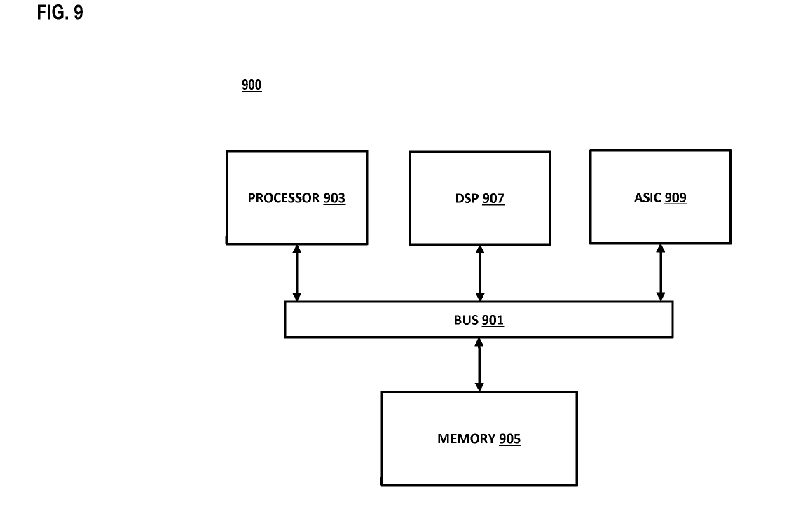

FIG. 9 illustrates a chip set 900 upon which an embodiment of the invention may be implemented. Chip set 900 is programmed to provide for implementing a network of cameras for receiving and providing various services and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of FIGS. 3-5.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
creating a network of a plurality of cameras, wherein the plurality of cameras are associated with a plurality of users participating in the network;
stitching one or more images, one or more videos, or a combination thereof captured by the plurality of cameras to generate a composite image, a composite video, or a combination thereof; and
providing access to the composite image, the composite video, the network, or a combination thereof to the plurality of users.

2. A method of claim 1, further comprising:
determining whether to include one or more candidate cameras in the plurality of cameras based on orientation information, field of view information, location information, or a combination thereof associated with the one or more candidate cameras.

3. A method of claim 2, further comprising:
determining a sequence of the one or more images, the one or more videos, or a combination thereof for generating the composite image, the composite video, or a combination thereof based on the orientation information, the field of view information, the location information, or a combination thereof.

4. A method of claim 2, further comprising:
determining the orientation information, the field of view information, the location information, or a combination thereof based on image processing information, location sensor information, micro-location information, or a combination thereof.

5. A method of claim 1, further comprising:
initiating a tracking of an object by processing the composite image, the composite video, the one or more images, the one or more videos, or a combination thereof to determine a presence, a movement, or a combination thereof of the object; and
generating an alert message based on the tracking.

6. A method of claim 5, further comprising:
receiving a request to initiate the tracking,
wherein the request specifies object identifying information, and
wherein the processing of the composite image, the composite video, or a combination thereof is further based on the object identifying information.

7. A method of claim 5, further comprising:
granting access to the composite image, the composite video, the one or more images, the one or more videos, or a combination thereof to an entity other than the plurality of users based on the tracking of the object, a detected event associated with the object, or a combination thereof.

8. A method of claim 1, further comprising:
initiating an activation or a deactivation of at least one of the plurality of cameras based on presence information associated with the one or more users.

9. A method of claim 1, further comprising:
initiating a storage of the composite image, the composite video, the one or more images, the one or more videos, or a combination thereof independently or redundantly across one or more data storage repositories associated with the plurality of users.

10. An apparatus comprising:
a processor; and
a memory including computer program code for one or more programs,
the memory and the computer program code configured to, with the processor, cause the apparatus to perform at least the following:
create a network of a plurality of cameras, wherein the plurality of cameras are associated with a plurality of users participating in the network;
stitch one or more images, one or more videos, or a combination thereof captured by the plurality of cameras to generate a composite image, a composite video, or a combination thereof; and
provide access to the composite image, the composite video, the network, or a combination thereof to the plurality of users.

11. An apparatus of claim 10, wherein the apparatus is further caused to:
determine whether to include one or more candidate cameras in the plurality of cameras based on orientation information, field of view information, location information, or a combination thereof associated with the one or more candidate cameras.

12. An apparatus of claim 11, wherein the apparatus is further caused to:
determine a sequence of the one or more images, the one or more videos, or a combination thereof for generating the composite image, the composite video, or a combination thereof based on the orientation information, the field of view information, the location information, or a combination thereof.

13. An apparatus of claim 11, wherein the apparatus is further caused to:
determine the orientation information, the field of view information, the location information, or a combination thereof based on image processing information, location sensor information, micro-location information, or a combination thereof.

14. An apparatus of claim 10, wherein the apparatus is further caused to:
initiate a tracking of an object by processing the composite image, the composite video, the one or more images, the one or more videos, or a combination thereof to determine a presence, a movement, or a combination thereof of the object; and
generate an alert message based on the tracking.

15. An apparatus of claim 14, wherein the apparatus is further caused to:
receive a request to initiate the tracking,
wherein the request specifies object identifying information, and
wherein the processing of the composite image, the composite video, or a combination thereof is further based on the object identifying information.

16. An apparatus of claim 14, wherein the apparatus is further caused to:
grant access to the composite image, the composite video, the one or more images, the one or more videos, or a combination thereof to an entity other than the plurality of users based on the tracking of the object, a detected event associated with the object, or a combination thereof.

17. A system comprising:
A networked camera platform configured to create a network of a plurality of cameras, wherein the plurality of cameras are associated with a plurality of users participating in the network; stitch one or more images, one or more videos, or a combination thereof captured by the plurality of cameras to generate a composite image, a composite video, or a combination thereof; and provide access to the composite image, the composite video, the network, or a combination thereof to the plurality of users.

18. A system of claim 17, wherein the networked camera platform is further configured to:
determine whether to include one or more candidate cameras in the plurality of cameras based on orientation information, field of view information, location information, or a combination thereof associated with the one or more candidate cameras.

19. A system of claim 18, wherein the networked camera platform is further configured to:
determine a sequence of the one or more images, the one or more videos, or a combination thereof for generating the composite image, the composite video, or a combination thereof based on the orientation information, the field of view information, the location information, or a combination thereof.

20. A system of claim 18, wherein the networked camera platform is further configured to:
determine the orientation information, the field of view information, the location information, or a combination thereof based on image processing information, location sensor information, micro-location information, or a combination thereof.

21. A system of claim 17, wherein the networked camera platform is further configured to:
initiate a tracking of an object by processing the composite image, the composite video, the one or more images, the one or more videos, or a combination thereof to determine a presence, a movement, or a combination thereof of the object; and
generate an alert message based on the tracking.

22. A system of claim 21, wherein the networked camera platform is further configured to:
receive a request to initiate the tracking,
wherein the request specifies object identifying information, and
wherein the processing of the composite image, the composite video, or a combination thereof is further based on the object identifying information.

23. A system of claim 21, wherein the networked camera platform is further configured to:
grant access to the composite image, the composite video, the one or more images, the one or more videos, or a combination thereof to an entity other than the plurality of users based on the tracking of the object, a detected event associated with the object, or a combination thereof.
